(19) United States
(12) Patent Application Publication
(10) Pub. No.: US 2023/0399466 A1
(43) Pub. Date: Dec. 14, 2023

(54) LOW DENSITY COMPOSITIONS CONTAINING POLYETHER BLOCK AMIDES AND HOLLOW GLASS REINFORCEMENTS AND USE OF SAME

(71) Applicant: ARKEMA FRANCE, Colombes (FR)

(72) Inventors: Mathieu SABARD, SERQUIGNY (FR); Guillaume VINCENT, Changshu, Jiangsu (CN); Cristian TITTOTO, Castelcucco (TV) (IT)

(73) Assignee: ARKEMA FRANCE, Colombes (FR)

(21) Appl. No.: 18/248,926

(22) PCT Filed: Oct. 12, 2021
(86) PCT No.: PCT/FR2021/051765

§ 371 Date: Apr. 13, 2023

(30) Foreign Application Priority Data
Oct. 15, 2020 (FR) FR2010535

(51) Int. Cl. C08G 69/40; C08K 7/28; C08K 7/06

(52) U.S. Cl. CPC C08G 69/40; C08K 7/28; C08K 7/06; C08K 2201/003

(57) ABSTRACT

A molding composition including by weight: (A) 45% to 90%, particularly 60% to 80%, more particularly 62.5% to 77.5% of at least one copolyamide with amide units (Bal) and polyether units (Ba2), (B) 5% to 30%, particularly 10% to 20%, more particularly 12.5% to 17.5% of carbon fibers, (C) 5% to 20%, particularly 10% to 15% of a hollow glass reinforcement, (D) 0% to 5%, preferably 0.1% to 2% of at least one additive, the sum of the proportions of each constituent (A)+(B)+(C)+(D) of the composition being equal to 100%.

### TECHNICAL FIELD

The present invention relates to compositions comprising at least one copolyamide with amide units and polyether units (or polyether block amide or PEBA), carbon fibers and at least one hollow glass reinforcement having low density, less than or equal to 1.02, having a high modulus, in particular a tensile modulus at 23° C., according to ISO 527:2012, greater than 1500 MPa, and having good impact resistance, in particular when cold (−30° C. and less), good elongation at break and good injectability by an injection molding method, and to the use of same for manufacturing an article, especially by injection, in particular for electronics, sports, motor vehicles or industry, in particular for manufacturing an aircraft.

### PRIOR ART

Articles for electronics, sports, motor vehicle or industrial applications must all become lighter in order to consume less energy or minimize the energy expended when used in the context of sports in particular. They must also allow the athlete to obtain the necessary sensations for controlling movements and rapidly transmitting muscle pulses.

PEBAs, or PEBA-based compositions, are often used in these applications where the liveliness, lightness, and ductility, in particular between the ambient temperature and very low temperatures (for example −30° C.) of the article comprising these compositions are of great importance.

The density of PEBAs as measured in accordance with ISO 1183-3:1999 is generally greater than or equal to 1. Nevertheless, this density may be too high for certain applications such as those as mentioned above, and especially for sport.

In addition, PEBAs may have a modulus that is too low for certain applications such as those mentioned above.

In addition, the combination of polyamide, hollow glass beads and carbon fibers is also disclosed in the literature.

Thus, international application WO20094624 discloses compositions comprising a thermoplastic resin, carbon fibers and hollow glass beads. This composition does not comprise PEBA.

Application US20050238864 discloses compositions comprising a thermoplastic resin, carbon fibers and hollow glass beads. This composition does not comprise PEBA.

Application US20170058123 describes compositions comprising a thermoplastic resin, carbon fibers and hollow glass beads. This composition does not comprise PEBA.

Application JP2007119669 discloses compositions comprising a polyamide resin, carbon fibers and hollow glass beads. This composition does not comprise PEBA.

Application JP2013010847 describes compositions comprising a polyamide resin, carbon fibers and hollow glass beads. This composition does not comprise PEBA.

Application JP19930061701 discloses compositions comprising a polyamide resin, carbon fibers and hollow glass beads. This composition does not comprise PEBA.

In addition, none of these applications offer a compromise of properties that is necessary for uses such as in electronics, sports, motor vehicles or industry, and especially low density, less than or equal to 1.02, high rigidity, good impact resistance at very low temperature (−30° C. or less) and good elongation at break.

Therefore, the present invention relates to a molding composition comprising by weight:
(A) 45% to 90%, particularly 60% to 80%, more particularly 62.5% to 77.5% of at least one copolyamide with amide units (Ba1) and polyether units (Ba2),
(B) 5% to 30%, particularly 10% to 20%, more particularly 12.5% to 17.5% of carbon fibers,
(C) 5% to 20%, particularly 10% to 15% of a hollow glass reinforcement,
(D) 0% to 5%, preferably 0.1% to 2% of at least one additive, the sum of the proportions of each constituent (A)+(B)+(C)+(D) of the composition being equal to 100%.

Unexpectedly, the inventors have found that the addition of hollow glass beads, in a specific proportion range, and of carbon fibers, in a specific range, to PEBAs makes it possible to obtain compositions that have low density, less than or equal to 1.02, having high rigidity, and having good impact strength, especially when cold (−30° C. and less), good elongation at break and good injectability by an injection molding method.

### Regarding PEBA (A)

Polyether block amides (PEBAs) are copolymers with amide units (Ba1) and polyether units (Ba2), said amide unit (Ba1) corresponding to an aliphatic repeating unit chosen from a unit obtained from at least one amino acid or a unit obtained from at least one lactam, or a unit X·Y obtained from the polycondensation:
of at least one diamine, said diamine preferably being chosen from a linear or branched aliphatic diamine or a mixture thereof, and
of at least one carboxylic diacid, said diacid preferably being chosen from:
a linear or branched aliphatic diacid, or a mixture thereof,
said diamine and said diacid comprising 4 to 36 carbon atoms, advantageously 6 to 18 carbon atoms;
said polyether units (Ba2) being especially derived from at least one polyalkylene ether polyol, especially a polyalkylene ether diol,

PEBAs especially result from the copolycondensation of polyamide sequences with reactive ends with polyether sequences with reactive ends, such as, inter alia:
1) Polyamide sequences with diamine chain ends with polyoxyalkylene sequences with dicarboxylic chain ends.
2) Polyamide sequences with dicarboxylic chain ends with polyoxyalkylene sequences with diamine chain ends obtained by cyanoethylation and hydrogenation of alpha-omega dihydroxylated aliphatic polyoxyalkylene sequences referred to as polyalkylene ether diols (polyether diols).
3) Polyamide sequences with dicarboxylic chain ends with polyether diols, the products obtained being, in this particular case, polyether ester amides. The copolymers of the invention are advantageously of this type.

The polyamide sequences with dicarboxylic chain ends come for example from the condensation of polyamide precursors in the presence of a chain-limiting carboxylic diacid.

The polyamide sequences with diamine chain ends come for example from the condensation of polyamide precursors in the presence of a chain-limiting diamine.

The polyamide and polyether block polymers may also comprise randomly distributed units. These polymers may be prepared by the simultaneous reaction of polyether and polyamide block precursors.

For example, polyether diol, polyamide precursors and a chain-limiting diacid can be reacted. The result is a polymer having essentially polyether blocks, polyamide blocks with highly variable length, but also the various reagents having randomly reacted which are distributed randomly (statistically) along the polymer chain.

Alternatively, polyether diamine, polyamide precursors and a chain-limiting diacid can be reacted. The result is a polymer having essentially polyether blocks, polyamide blocks with highly variable length, but also the various reagents having randomly reacted which are distributed randomly (statistically) along the polymer chain.

Amide Unit (Ba1):

The amide unit (Ba1) corresponds to an aliphatic repeating unit as defined above.

Advantageously, the amide unit (Ba1) is chosen from polyamide 11, polyamide 12, polyamide 610, polyamide 612, polyamide 1010, polyamide 1012, in particular polyamide 11.

More advantageously, the amide unit (Ba1) is chosen from polyamide 11 and polyamide 12, in particular polyamide 11.

In another embodiment, the amide unit (Ba1) excludes PA11.

Polyether Unit (Ba2):

The polyether units are especially derived from at least one polyalkylene ether polyol, in particular they are derived from at least one polyalkylene ether polyol, in other words, the polyether units consist of at least one polyalkylene ether polyol. In this embodiment, the expression “of at least one polyalkylene ether polyol” means that the polyether units consist exclusively of alcohol chain ends and therefore cannot be a polyether diamine triblock type compound.

The composition of the invention therefore is free of polyether diamine triblock.

Advantageously, the polyether units (Ba2) are chosen from polyethylene glycol (PEG), polypropylene glycol (PPG), polytrimethylene glycol (PO3G), polytetramethylene glycol (PTMG) and the mixtures or copolymers thereof, in particular PTMG.

The number average molecular weight (Mn) of the polyether blocks is advantageously between 200 and 4000 g/mol, preferably between 250 and 2500 g/mol, especially between 300 and 1100 g/mol.

The PEBA can be prepared by the following method in which:
in a first step, the polyamide blocks (Ba1) are prepared by polycondensation of the lactam(s), or
of the amino acid(s), or
of the diamine(s) and of the carboxylic diacid(s); and if necessary, of the comonomer(s) chosen from the lactams and the alpha-omega aminocarboxylic acids;
in the presence of a chain limiter chosen from the carboxylic diacids; then
in a second step, the polyamide blocks (Ba1) obtained are reacted with polyether blocks (Ba2) in the presence of a catalyst.

The general method for two-step preparation of the copolymers of the invention is known and is described, for example, in French patent FR 2 846 332 and in European patent EP 1 482 011.

The reaction for forming the block (Ba1) usually takes place between 180 and 300° C., preferably between 200 and 290° C.; the pressure inside the reactor is between 5 and 30 bar and is maintained for about 2 to 3 hours. The pressure is slowly reduced by bringing the reactor to atmospheric pressure, and then the excess water is distilled off, for example for an hour or two.

Once the polyamide with carboxylic acid ends has been prepared, the polyether and a catalyst are added. The polyether may be added in one or more stages, as can the catalyst. In an advantageous embodiment, the polyether is added first, and the reaction of the OH ends of the polyether and the COOH ends of the polyamide begins with the formation of ester bonds and the removal of water. As much water as possible is removed from the reaction medium by distillation, then the catalyst is introduced to complete the bonding of the polyamide blocks and the polyether blocks. This second step is carried out under stirring, preferably under a vacuum of at least 15 mm Hg (2000 Pa) at a temperature such that the reagents and copolymers obtained are in the molten state. As an example, this temperature can be between 100 and 400° C. and most commonly 200 and 300° C. The reaction is monitored by measuring the torque exerted by the molten polymer on the stirrer or by measuring the electrical power consumed by the stirrer. The end of the reaction is determined by the value of the target torque or power.

One or more molecules used as antioxidant, for example Irganox® 1010 or Irganox® 245, may also be added during the synthesis, at the moment deemed most appropriate.

The PEBA preparation process may also be considered so that all the monomers are added at the beginning, in a single step, in order to perform the polycondensation:
of the lactam(s), or
of the amino acid(s), or
of the diamine(s) and the carboxylic diacid(s); and optionally, of the other polyamide comonomer(s);
   in the presence of a chain limiter chosen from the carboxylic diacids;
   in the presence of the blocks (Ba2) (polyether);
   in the presence of a catalyst for the reaction between the soft blocks (Ba2) and the blocks (Ba1).

Advantageously, said carboxylic diacid is used as a chain limiter, which is introduced in excess with respect to the stoichiometry of the diamine(s).

Advantageously, a derivative of a metal chosen from the group formed by titanium, zirconium and hafnium or a strong acid such as phosphoric acid, hypophosphorous acid or boric acid is used as catalyst.

The polycondensation can be carried out at a temperature of 240 to 280° C.

Generally speaking, the known copolymers with ether and amide units consist of linear and semi-crystalline aliphatic polyamide sequences (for example Arkema's “Pebax”).

In one embodiment, the copolyamide with amide units (Ba1) and polyether units (Ba2) has a density greater than or equal to 1, in particular greater than or equal to 1.01, especially greater than or equal to 1.02, as determined in accordance with ISO 1183-3:1999.

Advantageously, the modulus of the PEBA (A) is less than 250 MPa, especially less than 200 MPa, in particular less than 150 MPa, more particularly less than 100 MPa as measured according to standard ISO 178:2010, at 23° C.

### Regarding Carbon Fibers (B)

The carbon fibers in the semi-crystalline aliphatic polyamide molding composition according to the invention are preferably present in an amount of from 5% to 30% by weight, particularly from 10% to 20%, more particularly from 12.5% to 17.5% by weight, with respect to the sum of the constituents of the composition.

The carbon fibers used in the molding composition defined above may especially be in the form of cut (or short) fibers or in the form of cut (or short) fiber bundles or in the form of crushed carbon fibers, or in the form of grains of rice or in granulated form.

Before compounding, the carbon fibers are preferably cut (or short) carbon fibers and have a length with an arithmetic mean from 0.1 to 50 mm, in particular between 2 and 10 mm.

Before compounding, the crushed carbon fibers have a length with an arithmetic mean from 50 μm to 400 μm.

After compounding, in the composition to be molded, the crushed carbon fibers have a length with an arithmetic mean of less than 400 μm.

After compounding, in the composition to be molded, the short carbon fibers have a length with an arithmetic mean from 100 to 600 μm, in particular from 150 to 500 μm.

The length of fibers having an arithmetic mean as defined above is determined according to ISO 22314:2006 (E).

The carbon fibers can be manufactured, for example, from PAN (polyacrylonitrile), or carbon pitch or cellulose-based fibers.

The carbon fibers in the composition can also be anisotropes.

The carbon fibers used in the polyamide composition have a diameter from 5 to 12 μm, a tensile strength of 1000 to 7000 MPa and an elastic modulus of 200 to 700 GPa.

Usually, the carbon fibers are produced by exposing a suitable polymer fiber made from polyacrylonitrile, pitch or rayon under changing controlled atmospheric and temperature conditions. For example, carbon fibers can be produced by stabilizing PAN yarns or fabrics in an oxidizing atmosphere at 200 to 300 degrees Celsius and subsequent carbonization in an inert atmosphere above 600 degrees Celsius. Such methods are cutting-edge and disclosed, for example, in H. Heissler, “Reinforced plastics in the aerospace industry,” Verlag W. Kohlhammer, Stuttgart, 1986.

With the aim of improving the physicochemical links between polymer and fibers, fiber manufacturers use sizings, the composition and level of which may vary.

The term “sizing” refers to the surface treatments applied to the reinforcing fibers leaving the nozzle (textile sizing) and on the fabrics (plastic sizing). They are generally organic in nature (thermosetting or thermoplastic resin type).

“Textile” sizing applied on the fibers leaving the die consists of depositing a bonding agent ensuring the cohesion of the fibers relative to one another, decreasing abrasion and facilitating subsequent handling (weaving, draping, knitting) and preventing the formation of electrostatic charges.

“Plastic” sizing or “finish” applied on fabrics consists of depositing a coupling agent, the roles of which are to ensure a physicochemical bond between the fibers and the resin and to protect the fiber from its environment.

In one embodiment, the carbon fiber of the component can be a recycled carbon fiber.

### Regarding Hollow Glass Reinforcement (C)

The hollow glass reinforcement corresponds to a glass reinforcement material with a hollow (as opposed to solid) structure that can have any shape as long as it is hollow.

The hollow glass reinforcer can especially be hollow glass fibers or hollow glass beads. In particular, the hollow glass reinforcement is chosen from hollow glass beads.

The short hollow glass fibers preferably have a length of between 2 and 13 mm, preferably 3 to 8 mm, before the compositions are used.

Hollow glass fibers means glass fibers in which the hollow (or hole or window or void) within the fiber is not necessarily concentric relative to the outer diameter of said fiber.

The hollow glass fiber can be:
either with a circular cross-section having an outer diameter from 7 to 75 μm, preferably from 9 to 25 μm, more preferably from 10 to 12 μm.

It is obvious that the diameter of the hollow (the term “hollow” can also be called hole or window or void) is not equal to the outer diameter of the hollow glass fiber.

Advantageously, the diameter of the hollow (or hole or window) is from 10% to 80%, in particular from 60 to 80% of the outer diameter of the hollow fiber.
or with a non-circular cross-section having a L/D ratio (where L represents the largest dimension of the cross-section of the fiber and D the smallest dimension of the cross-section of said fiber) between 2 and 8, in particular between 2 and 4. L and D can be measured by scanning electron microscopy (SEM).

In one embodiment, the hollow glass reinforcement is hollow glass beads.

The hollow glass beads are present in the composition in an amount of from 5% to 20% by weight, in particular from 10% to 15% by weight.

The hollow glass beads have a compressive strength, measured according to ASTM D 3102-72 (1982) in glycerol, of at least 50 MPa and particularly preferably of at least 100 MPa.

Advantageously, the hollow glass beads have a volume mean diameter d₅₀ of 10 to 80 μm, preferably of 13 to 50 μm, measured using laser diffraction in accordance with the standard ASTM B 822-17.

The hollow glass beads can be surface treated with, for example, systems based on aminosilanes, epoxysilanes, polyamides, in particular hydrosoluble polyamides, fatty acids, waxes, silanes, titanates, urethanes, polyhydroxyethers, epoxides, nickel or mixtures thereof can be used for this purpose. The hollow glass beads are preferably surface treated with aminosilanes, epoxysilanes, polyamides or mixtures thereof.

The hollow glass beads can be formed from a borosilicate glass, preferably from a calcium-borosilicate sodium-oxide carbonate glass.

The hollow glass beads preferably have a real density of 0.10 to g/cm³, preferably from 0.20 to 0.60 g/cm³, particularly preferably from to 0.50 g/cm³, measured according to the standard ASTM D 2840-69 (1976) with a gas pycnometer and helium as the measuring gas.

Advantageously, the hollow glass beads have a compressive strength, as measured according to ASTM D 3102-72 (1982) in glycerol, of at least 50 MPa, in particular of at least 100 MPa.

### Regarding the Composition

In a first variant, said molding composition comprises by weight:
(A) 45% to 90%, particularly 60% to 80%, more particularly 62.5% to 77.5% of at least one copolyamide with amide units (Ba1) and polyether units (Ba2),
(B) 5% to 30%, particularly 10% to 20%, more particularly 12.5% to 17.5% of carbon fibers,
(C) 5% to 20%, particularly 10% to 15% of a hollow glass reinforcement,
(D) 0% to 5%, preferably 0.1% to 2% of at least one additive,
the sum of the proportions of each constituent (A)+(B)+(C)+(D) of the composition being equal to 100%.

In one embodiment of the first variant, said molding composition consists of (by weight):
(A) 45% to 90%, particularly 60% to 80%, more particularly 62.5% to 77.5% of at least one copolyamide with amide units (Ba1) and polyether units (Ba2),
(B) 5% to 30%, particularly 10% to 20%, more particularly 12.5% to 17.5% of carbon fibers,
(C) 5% to 20%, particularly 10% to 15% of a hollow glass reinforcement,
(D) 0% to 5%, preferably 0.1% to 2% of at least one additive,
the sum of the proportions of each constituent (A)+(B)+(C)+(D) of the composition being equal to 100%.

In a second variant, said composition comprises by weight:
(A) 60% to 80%, in particular 62.5% to 77.5% of at least one copolyamide with amide units (Ba1) and polyether units (Ba2),
(B) 10% to 20%, in particular 12.5% to 17.5% of carbon fibers,
(C) 10% to 15% of a hollow glass reinforcement,
(D) 0% to 5%, preferably 0.1% to 2% of at least one additive,
the sum of the proportions of each constituent (A)+(B)+(C)+(D) of the composition being equal to 100%.

In one embodiment of the second variant, said molding composition consists of (by weight):
(A) 60% to 80%, in particular 62.5% to 77.5% of at least one copolyamide with amide units (Ba1) and polyether units (Ba2),
(B) 10% to 20%, in particular 12.5% to 17.5% of carbon fibers,
(C) 5% to 20%, particularly 10% to 15% of a hollow glass reinforcement,
(D) 0% to 5%, preferably 0.1% to 2% of at least one additive,
the sum of the proportions of each constituent (A)+(B)+(C)+(D) of the composition being equal to 100%.

In a third variant, said composition comprises by weight:
(A) 62.5% to 77.5% of at least one copolyamide with amide units (Ba1) and polyether units (Ba2),
(B) 12.5% to 17.5% of carbon fibers,
(C) 10% to 15% of a hollow glass reinforcement,
(D) 0% to 5%, preferably 0.1% to 2% of at least one additive,
the sum of the proportions of each constituent (A)+(B)+(C)+(D) of the composition being equal to 100%.

In one embodiment of the third variant, said molding composition consists of by weight:
(A) 62.5% to 77.5% of at least one copolyamide with amide units (Ba1) and polyether units (Ba2),
(B) 12.5% to 17.5% of carbon fibers,
(C) 10% to 15% of a hollow glass reinforcement,
(D) 0% to 5%, preferably 0.1% to 2% of at least one additive,
the sum of the proportions of each constituent (A)+(B)+(C)+(D) of the composition being equal to 100%.

Advantageously, the molding composition according to the invention has a density less than or equal to 1.02, preferably less than or equal to 1.01, more preferably less than or equal to 1, even more preferably less than 1, as determined in accordance with ISO 1183-3:1999.

Advantageously, the amide unit (Ba1) corresponds to an aliphatic repeating unit as defined above.

Advantageously, the amide unit (Ba1) of the copolyamide of the composition of the invention is chosen from polyamide 11, polyamide 12, polyamide 610, polyamide 612, polyamide 1010, polyamide 1012, in particular polyamide 11.

More advantageously, the amide unit (Ba1) of the copolyamide of the composition of the invention is chosen from polyamide 11 and polyamide 12, in particular polyamide 11.

In one embodiment, said composition defined above has a tensile modulus at 23° C., according to ISO 527:2012, greater than 1500 MPa.

In one embodiment of all the variants, the amide unit (Ba1) excludes PA1.

### Regarding the Additive (D)

The additive is optional and comprised in an amount of from 0% to 5%, in particular from 0.1% to 2% by weight.

The additive is chosen from fillers, dyes, stabilizers, plasticizers, surfactants, nucleating agents, pigments, brighteners, antioxidants, lubricants, flame retardants, natural waxes, impact modifiers, laser marking additives, and mixtures thereof.

As an example, the stabilizer may be a UV stabilizer, an organic stabilizer or more generally a combination of organic stabilizers, such as a phenol antioxidant (for example of the type Irganox® 245 or 1098 or 1010 by Ciba-BASF), a phosphite antioxidant (for example Irgafos® 126 by Ciba-BASF) and even optionally other stabilizers like a HALS, which means hindered amine light stabilizer (for example Tinuvin® 770 by Ciba-BASF), an anti-UV (for example Tinuvin® 312 by Ciba), a phosphorus-based stabilizer. Amine antioxidants such as Crompton's Naugard® 445 or polyfunctional stabilizers such as Clariant's Nylostab® S-EED can also be used.

This stabilizer may also be a mineral stabilizer, such as a copper-based stabilizer. By way of example of such mineral stabilizers, mention may be made of halides and copper acetates. Secondarily, other metals such as silver may optionally be considered, but these are known to be less effective. These copper-based compounds are typically associated with alkali metal halides, particularly potassium.

By way of example, the plasticizers are chosen from benzene sulfonamide derivatives, such as n-butyl benzene sulfonamide (BBSA); ethyl toluene sulfonamide or N-cyclohexyl toluene sulfonamide; hydroxybenzoic acid esters, such as 2-ethylhexyl parahydroxybenzoate and 2-decylhexyl parahydroxybenzoate; esters or ethers of tetrahydrofurfuryl alcohol, like oligoethyleneoxytetrahydrofurfuryl alcohol; and esters of citric acid or of hydroxy-malonic acid, such as oligoethyleneoxy malonate.

Using a mixture of plasticizers would not be outside the scope of the invention.

By way of example, the fillers can be selected from silica, graphite, expanded graphite, carbon black, kaolin, magnesia, slag, talc, wollastonite, mica, nanofillers (carbon nanotubes), pigments, metal oxides (titanium oxide), metals, advantageously wollastonite and talc, preferably talc.

By way of example, the impact modifiers are polyolefins having a modulus <200 MPa, in particular <100 MPa, as measured according to the standard ISO 178:2010, at 23° C.

In one embodiment, the impact modifier is chosen from a functionalized or non-functionalized polyolefin having a modulus <200 MPa, in particular <100 MPa, and mixtures thereof.

Advantageously, the functionalized polyolefin has a function selected from the maleic anhydride, carboxylic acid, carboxylic anhydride and epoxide functions, and is in particular selected from the ethylene/octene copolymers, ethylene/butene copolymers, ethylene/propylene (EPR) elastomers, elastomeric ethylene-propylene-diene copolymers (EPDM) and ethylene/alkyl (meth)acrylate copolymers.

By way of example, the laser marking additives are: Iriotec® 8835/Iriotec® 8850 from MERCK and Laser Mark® 1001074-E/Laser Mark® 1001088-E from Ampacet Corporation.

According to another aspect, the present invention relates to the use of a composition as defined above, for manufacturing an article, notably for electronics, sports, motor vehicles or industry.

All the technical features defined above for the composition as such are also valid for the use thereof.

In one embodiment, the article is manufactured by injection molding.

According to yet another aspect, the present invention relates to an article obtained by injection molding with a composition as defined above.

All the technical features detailed above for the composition as such are valid for the article.

According to another aspect, the present invention relates to the use of 5% to 20% by weight of a hollow glass reinforcement with at least one PEBA and carbon fibers optionally comprising at least one additive, said PEBA being present in an amount of from 45% to 90% by weight, said carbon fibers being present in an amount of from 5% to 30% by weight, and said additive being comprised in an amount of from 0% to 5% by weight, to make up a composition of which the density is lower than that of said PEBA used alone with optionally at least one additive, and said density of said composition being less than or equal to 1.02.

All the technical features defined above for the composition as such are valid for the use thereof.

### EXAMPLES

Preparation of the Compositions of the Invention and Mechanical Properties:

The compositions of Table 1 were prepared by mixing PEBA granules (Arkema) in the molten state with the hollow glass beads, the carbon fibers and optionally the additives, and those of Table 2 were prepared by mixing PEBA granules (Arkema) in the molten state and the additives. This mixture was made by compounding on a 26 mm diameter twin-screw co-rotating extruder with a flat temperature profile (T°) at 250° C. The screw speed is 250 rpm and the flow rate is 15 kg/h.

The introduction of the hollow glass beads and the carbon fibers is carried out with a side feeder.

The one or more PEBAs and the additives are added during the compounding process in the main hopper.

The compositions were then molded on an injection molding machine (Engel) at a setpoint temperature of 250° C. and a molding temperature of 50° C. in the shape of 1A dumbbells or impact bars in order to study the properties of the compositions according to the standards below.

The tensile properties were measured at 23° C. according to the standard ISO 527-1:2019 on dumbbells of type 1A.

The machine used is of the INSTRON 5966 type. The speed of the crosshead is 1 mm/min for the modulus measurement and 5 mm/min for measuring the elongation at break. The test conditions are 23° C.+/−2° C. at a relative humidity of 50%+/−10%, on dry samples.

The impact strength was determined according to ISO 179-1:2010/1eU and ISO 179-1:2010/1eA (Charpy impact) on bars of size 80 mm×10 mm×4 mm, non-notched and notched, respectively, at a temperature of 23° C.+/−2° C. at a relative humidity of 50%+/−10%, or at −30° C.+/−2° C. at a relative humidity of 50%+/−10%, or at −35° C.+/−2° C. at a relative humidity of 50%+/−10% on dry samples.

The density of the injected compositions was measured according to the standard ISO 1183-3:1999 at a temperature of 23° C. on bars of size 80 mm×10 mm×4 mm.

The various compositions (E1 to E5: compositions of the invention) and (comparative CE1 to CE8) and their properties are presented in Tables 1 and 2.

TABLE 1

| The contents are | | | | | | | | | | |
|---|---|---|---|---|---|---|---|---|---|---|
| expressed as a % | | | | | | | | | | |
| by weight | CE 1 | CE2 | CE3 | CE4 | CE5 | E1 | E2 | E3 | E4 | E5 |
| PA12 | 74.40 | 79.40 | | | | | | | | |
| PEBA: | | | 84.70 | | | 79.40 | 74.70 | | | |
| PA12/PTMG | | | | | | | | | | |
| (5000/650 g/mol) | | | | | | | | | | |
| PEBA | | | | 84.70 | | | | 74.70 | | |
| PA12/PTMG | | | | | | | | | | |
| (2000/1000 g/mol) | | | | | | | | | | |
| PEBA | | | | | 84.70 | | | | 74.70 | 74.70 |
| PA11/PTMG | | | | | | | | | | |
| ((1000/1000 g/mol) | | | | | | | | | | |
| iM16k hollow glass | 10.00 | 10.00 | 0 | 0 | 0 | 10.00 | 10.00 | 10.00 | 10.00 | 10.00 |
| beads from 3M | | | | | | | | | | |
| (TENAX ®-A IM | | | 15.00 | 15.00 | 15.00 | | 15.00 | 15.00 | 15.00 | |
| P303 carbon fiber | | | | | | | | | | |
| TENAX ®- E-HT | 15.00 | 10.00 | | | | 10.00 | | | | 15.00 |
| C604 carbon fiber | | | | | | | | | | |
| additives | 0.60 | 0.6 | 0.60 | 0.60 | 0.60 | 0.30 | 0.30 | 0.30 | 0.30 | 0.30 |
| density (g/cm3) | 1.01 | 0.98 | 1.08 | 1.07 | 1.07 | 0.98 | 1.01 | 0.99 | 0.97 | 0.97 |
| Tensile modulus at | 10200 | 7400 | 6540 | 3520 | 2310 | 5500 | 6886 | 3765 | 1978 | 1853 |
| 23° C. (according to | | | | | | | | | | |
| ISO 527:2012) in | | | | | | | | | | |
| MPa | | | | | | | | | | |
| Notched Charpy | 16 | 12 | 28 | 38 | 39 | 22 | 21 | 34 | 34 | 32 |
| impact according to | | | | | | | | | | |
| ISO 179-1:2010/1eA | | | | | | | | | | |
| strength (kJ/m²) at | | | | | | | | | | |
| 23° C. | | | | | | | | | | |
| Notched Charpy | — | — | 14 | 27 | 33 | 12 | 12 | 21 | 31 | 30 |
| impact according to | | | | | | | | | | |
| ISO 179-1:2010/1eA | | | | | | | | | | |
| strength (kJ/m²) | | | | | | | | | | |
| at −30° C. | | | | | | | | | | |
| Notched Charpy | 9 | — | 11 | 18 | 28 | 13 | 11 | 18 | 27 | 25 |
| impact according to | | | | | | | | | | |
| ISO 179-1:2010/1eA | | | | | | | | | | |
| strength (kJ/m²) | | | | | | | | | | |
| at −35° C. | | | | | | | | | | |
| Non-notched Charpy | 60 | 64 | 80 | >90 | >90 | 75 | 73 | >90 | >90 | >90 |
| impact according to | | | | | | | | | | |
| ISO 179-1:2010/1eU | | | | | | | | | | |
| strength (kJ/m²) | | | | | | | | | | |
| at 23° C. | | | | | | | | | | |
| Non-notched Charpy | 60 | — | 75 | 87 | >90 | 65 | 63 | 80 | >90 | >90 |
| impact according to | | | | | | | | | | |
| ISO 179-1:2010/1eU | | | | | | | | | | |
| at −30° C. (kJ/m²) | | | | | | | | | | |
| Elongation | 4.5 | 5 | 8 | 11 | 14 | 7 | 6 | 9 | 13 | 13 |
| measured | | | | | | | | | | |
| according to ISO | | | | | | | | | | |
| 527-1:2019 (%) | | | | | | | | | | |

TABLE 2

| The contents are expressed as | | | |
|---|---|---|---|
| a % by weight | CE6 | CE7 | CE8 |
| PA12 | | | |
| PEBA: | 99.4 | | |
| PA12/PTMG (5000/650 g/mol) | | | |
| PEBA | | 99.4 | |
| PA12/PTMG (2000/1000 g/mol) | | | |
| PEBA | | | 99.4 |
| PA11/PTMG ((1000/1000 g/mol) | | | |
| iM16k hollow glass beads from 3M | 0 | 0 | 0 |
| (TENAX ®-A IM P303 carbon fiber | 0 | 0 | 0 |
| TENAX ®- E-HT C604 carbon fiber | | | |
| additives | 0.60 | 0.60 | 0.60 |
| density (g/cm3) | 1.01 | 1.01 | 1.03 |
| Tensile modulus at 23° C. (according | | | |
| to ISO 527: 2012) in MPa | | | |
| Notched Charpy impact according | 120 | No | No |
| to ISO 179-1: 2010/1 eA strength | | breakage | breakage |
| (kJ/m²) at 23° C. | | | |
| Notched Charpy impact according | 20 | No | No |
| to ISO 179-1: 2010/1 eA strength | | breakage | breakage |
| (kJ/m²) at −30° C. | | | |
| Notched Charpy impact according | 18 | No | No |
| to ISO 179-1: 2010/1 eA strength | | breakage | breakage |
| (kJ/m²) at −35° C. | | | |
| Non-notched Charpy impact | No | No | No |
| according to ISO 179-1: 2010/1 eU | breakage | breakage | breakage |
| strength (kJ/m²) at 23° C. | | | |
| Non-notched Charpy impact | No | No | No |
| according to ISO 179-1: 2010/1 eU | breakage | breakage | breakage |
| at −30° C. (kJ/m²) | | | |
| Elongation measured according to | >300 | >300 | >300 |
| ISO 527-1: 2019 (%) | | | |

The addition of hollow glass beads and carbon fibers to PEBA makes it possible to obtain compositions having significantly better impact properties, especially when cold, than comparative examples CE1 and CE2 (WO20094624).

The same applies for the elongations at break. Indeed, the compositions according to the invention have higher elongations than the comparative examples CE1 and CE2.

The addition of hollow glass beads and carbon fibers to PEBA makes it possible to obtain compositions having a density significantly lower than the density of comparative examples CE3, CE4 and CE5, while maintaining a high modulus and mechanical properties (elongation at break, impact properties) at a very good level.

When comparing CE3 with E2, CE4 with E3 and CE5 with E4, it can be seen that the addition of hollow glass beads in PEBA/CF only slightly reduces the impact strength, in particular when cold (−30 and −35), with the additional benefit of significantly reducing the density.

The dumbbells of type 1A and the impact bars were obtained by injection on an Engel-type injection molding machine:

TABLE 3

| | Injection | Mold | Injectability and |
|---|---|---|---|
| | temperature | temperature | surface appearance |
| Compositions | (° C.) | (° C.) | (visual) |
| CE1 | 285 | 80 | — |
| (on an Arburg | | | |
| injection press | | | |
| according to WO | | | |
| WO20094624) | | | |
| CE2 | 285 | 80 | — |
| (on an Arburg | | | |
| injection press | | | |
| according to WO | | | |
| WO20094624) | | | |
| CE3 | 250 | 50 | OK |
| CE4 | 250 | | OK |
| CE5 | 250 | | OK |
| E1 | 250 | | OK |
| E2 | 250 | | OK |
| E3 | 250 | | OK |
| E4 | 250 | | OK |
| E5 | 250 | | OK |

OK means that the injectability is good and the surface appearance is visually very good.

1. A molding composition comprising by weight:
(A) 45% to 90%,
(B) 5% to 30%,
(C) 5% to 20%,
(D) 0% to 5%,
the sum of the proportions of each constituent (A)+(B)+(C)+(D) of the composition being equal to 100%.

2. The composition as claimed in claim 1, wherein said amide unit (Ba1) corresponds to a repeating unit chosen from a unit obtained from at least one amino acid or a unit obtained from at least one lactam, or a unit X·Y obtained from the polycondensation of at least one diamine and at least one dicarboxylic acid.

3. The composition as claimed in claim 1, wherein the polyether units (Ba2) are chosen from polyethylene glycol (PEG), polypropylene glycol (PPG), polytrimethylene glycol (PO3G), polytetramethylene glycol (PTMG) and the mixtures or copolymers thereof.

4. The composition as claimed in claim 1, wherein the copolyamide with amide units (Ba1) and polyether units (Ba2) has a density greater than or equal to 1 as determined in accordance with ISO 1183-3:1999.

5. The composition as claimed in claim 1, wherein the molding composition has a density less than or equal to 1.02 as determined in accordance with ISO 1183-3:1999.

6. The composition as claimed in claim 1, wherein the hollow glass reinforcement is hollow glass beads.

7. The composition as claimed in claim 6, wherein the hollow glass beads have a volume mean diameter d₅₀ of 10 to 80 μm as measured using laser diffraction in accordance with the standard ASTM B 822-17.

8. The composition as claimed in claim 6, wherein the hollow glass beads have a real density of 0.10 to 0.65 g/cm³ measured according to ASTM D 2840-69 (1976) with a gas pycnometer and helium as the measuring gas.

9. The composition as claimed in claim 6, wherein the hollow glass beads have a compressive strength, as measured in accordance with ASTM D 3102-72 (1982) in glycerol.

10. The composition as claimed in claim 1, wherein the amide unit (Ba1) is chosen from polyamide 11, polyamide 12, polyamide 610, polyamide 612, polyamide 1010, polyamide 1012.

11. The composition as claimed in claim 1, wherein the amide unit (Ba1) is chosen from polyamide 11 and polyamide 12.

12. The composition as claimed in claim 1, wherein said at least one additive is chosen from fillers, dyes, stabilizers, plasticizers, surfactants, nucleating agents, pigments, whitening agents, antioxidants, lubricants, flame retardants, natural waxes, impact modifiers and mixtures thereof.

13. A method of using a composition as defined in claim 1, for the manufacture of an article.

14. The method as claimed in claim 13, wherein the article is manufactured by injection molding.

15. An article obtained by injection molding with a composition as defined in claim 1.

16. A method of combining 5 to 20% by weight of a hollow glass reinforcement with at least one PEBA and carbon fibers optionally comprising at least one additive, said PEBA being present in an amount of from 45% to 90% by weight, said carbon fibers being present in an amount of from 5% to 30% by weight and said additive being comprised in an amount of from 0% to 5% by weight, to make up a composition of which the density is less than that of said PEBA used alone with optionally at least one additive, and said density of said composition being less than or equal to 1.02.
